(19) United States
(12) Patent Application Publication
(10) Pub. No.: US 2014/0272096 A1
(43) Pub. Date: Sep. 18, 2014

(54) METHOD AND APPARATUS FOR REVEALING A HIDDEN ELEMENT

(71) Applicant: HALLMARK CARDS, INCORPORATED, Kansas City, MO (US)

(72) Inventors: STEPHEN DREW GLASSCOCK, OLATHE, KS (US); JODI ANN ABBOTT, HARRISONVILLE, MO (US); JENNIFER RICHARDS GARBOS, KANSAS CITY, MO (US); ROBERT EUGENE LANGLEY, KANSAS CITY, MO (US); LUIS RODRIGO PINEIRO, BETHLEHEM, PA (US)

(73) Assignee: HALLMARK CARDS, INCORPORATED, KANSAS CITY, MO (US)

(21) Appl. No.: 13/838,290

(22) Filed: Mar. 15, 2013

(51) Int. Cl. B44D 5/00

(52) U.S. Cl. CPC B44D 5/00
USPC 427/1; 401/118

(57) ABSTRACT

Kits and methods are provided for revealing a hidden element of an article. The article has printing thereon using a combination of visible ink materials and colorless ink materials. An activating solution is applied to a body part using an applicator. The body part is then contacted with the article. The activating solution causes the colorless ink materials to become visible thereby revealing a portion of the hidden element. The portion of the hidden element is revealed in a shape corresponding to the body part.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

Embodiments of the present invention are directed towards kits and methods for permanently revealing a hidden element of an article by contacting a body part to the article. The hidden element is revealed in a shape corresponding to the body part. By using the kits and methods described, for example, a gift giver is able to personalize a gift, such as a greeting card, in a shape that is unique to the gift giver, thereby creating a gift giver-specific sentiment.

### BRIEF DESCRIPTION OF THE DRAWINGS

Embodiments of the invention are described in detail below with reference to the attached drawing figures, wherein:

FIG. 1 depicts an exemplary article that is part of an exemplary kit used to reveal a hidden element of the article in accordance with embodiments of the present invention;

FIGS. 1A-1C depict several views of an applicator mitt in the exemplary kit in accordance with embodiments of the present invention;

FIG. 2 is an enlarged cross-sectional view of the article of FIG. 1 taken along the line 2-2;

FIG. 3 is a schematic representation of a process used to reveal a hidden element of an article in accordance with embodiments of the present invention;

FIGS. 4-5 are flow diagrams of exemplary methods of revealing a hidden element of an article in accordance with embodiments of the present invention; and

FIGS. 6-8 depict exemplary articles having hidden elements revealed in a shape corresponding to a body part in accordance with embodiments of the present invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

In general, the invention is directed to kits and methods for permanently revealing a hidden element of an article by contacting a body part to the article. As used throughout this application, the term “permanent” means non-transitory. However, it is not meant to imply that the hidden element may not fade over time or be replaced by another affirmative action (e.g., coloring over, applying a solution, etc.). The hidden element is revealed in a shape corresponding to the body part. Accordingly, in one aspect, the present invention is directed to a kit for revealing a hidden element. The kit includes an article having the hidden element. The article is printed using one or more visible ink materials and the hidden element is printed using one or more colorless ink materials. The kit further comprises an applicator containing an activating solution. The applicator is configured to apply the activating solution to a body part. Contact between the body part coated with the activating solution and the article causes the activating solution to reveal at least a portion of the hidden element in a shape corresponding to the body part.

In a second aspect, the present invention is directed to a method for revealing hidden elements of an article. The method comprises providing the article having the hidden elements. The article is printed using one or more visible ink materials, and the hidden elements are printed using one or more colorless ink materials. An applicator containing an activating solution is provided. The applicator is configured to apply the activating solution to a body part. Contact between the article and the body part coated with the activating solution causes at least a portion of the hidden elements to be revealed in a shape corresponding to the body part.

In yet another aspect, the present invention is directed to a method for revealing a hidden element of an article. The method comprises using an applicator to apply an activating solution to a body part and contacting the body part coated with the activating solution with at least a portion of the article to reveal at least a portion of the hidden element in a shape corresponding to the body part.

In an additional aspect, the present invention is directed to a kit for revealing a hidden element. The kit includes an article having the hidden element. The article is printed using one or more visible ink materials, and the hidden element is printed using one or more colorless ink materials. The kit further includes a mitt containing an activating solution. The mitt is used to apply the activating solution to a body part. In turn, contact between the body part and the article causes the activating solution to reveal the hidden element in a shape corresponding to the body part.

In an alternative embodiment, the present invention is directed to kits and methods for permanently revealing a hidden element of an article by contacting a body part to the article. The hidden element is revealed in a shape corresponding to the body part. Accordingly, in this embodiment the present invention is directed to a kit for revealing a hidden element. The kit comprises an article having the hidden element. The article is printed using one or more visible ink materials and one or more masking materials covering at least a portion of the one or more visible ink materials. The kit further comprises an applicator containing a de-masking agent. The applicator is configured to apply the de-masking agent to a body part. Contact between the body part coated with the de-masking agent and the article causes at least a portion of the masking material to become transparent thereby revealing the hidden element in a shape corresponding to the body part. Hidden elements of an article may also be revealed by other mechanisms such as the application of heat or cold, altering the pH, and the like.

Referring to FIG. 1 and FIGS. 1A-1C, a kit for revealing a hidden element of an article is depicted and is referenced generally by the numeral 100. The kit 100 includes an article 110, and an applicator 116 (shown in a front view 1A, a back view 1B, and an exposed view 1C). Although not shown, the kit 100 may further include objects useful for presenting the article 110 for display. Such objects depend on the nature of the article 110 but may include objects such as magnets, display stands, picture frames, objects used for hanging the article 110, and the like. As well, the kit 100 may include instructions as well as packaging materials designed to hold the contents of the kit 100. The quantity and nature of the items in the kit 100 are meant to be exemplary. The kit 100 may include fewer items than depicted or, alternatively, the kit 100 may include more items than depicted. For example, the kit 100 may optionally include a towlette containing a cleaning solution that is used to wipe the activating solution off of the body part after creating the gift giver-specific sentiment.

The article 110 may be a variety of articles such as, for example, a greeting card, a frame and its corresponding insert, gift wrap, a wall magnet, a holiday decoration, an ornament, wall art, a cover of a journal and/or notebook, and the like. This list is not meant to be limiting. It is contemplated that the article 110 may comprise any object capable of being personalized by the application of a body part to the object.

The article 110 may be constructed of a number of different substrates such as plastic, paper, card stock, metal, glass, cloth, wood, and any combination of the above. On a substrate of the article 110, one or more solid-colored areas, textual messages, and/or design elements may be printed using visible ink materials in a variety of colors. Additionally, on the substrate of the article 110, one or more solid-colored areas, textual messages, and/or design elements may be printed using colorless ink materials. Both the visible and colorless ink materials may comprise gels, lotions, liquids, powders, sprays, solutions, and the like. Areas printed using colorless ink materials may be considered hidden element areas since the content of these areas is not visible to the eye of a user until an activating solution is applied which renders the colorless ink visible. Exemplary colorless ink materials include leuco dyes that are activated and become permanently visible in a variety of colors upon application of an activating solution. Areas of the article 110 printed using colorless ink materials may be limited to a predefined area of the article 110. Alternatively, the entire surface of the article 110 may include elements printed using colorless ink materials. In another aspect of the invention, on the substrate of the article 110, one or more solid-colored areas, textual messages, and/or design elements may be printed using only colorless ink materials. Thus, before application of the activating solution, the article 110 may appear as a blank or white article with no visible ink showing. Any and all such aspects, and any combination thereof, are contemplated as being within the scope of the invention. By way of example only, the article 110 depicted in FIG. 1 includes a frame area 112 printed using only visible ink materials and a second frame insert area 114 printed using a combination of visible ink materials and colorless ink materials. Because the colorless ink materials in the second frame insert area 114 have not yet been activated, the hidden elements of the article 110 have not been revealed.

The applicator 116 may be shaped in a number of different configurations capable of applying an activating solution to a body part of a user (e.g., a palm of a hand). As shown in FIGS. 1A-1C, the applicator 116 may comprise a mitt containing the activating solution and designed to be worn on the fingers of a hand. Once the mitt has been placed on the fingers of the user, the user can contact the mitt to a body part such as, for example, the palm of the other hand or the palm of another user in order to apply the activating solution. Other exemplary body parts may include, for example, fingers, the sole of a foot, the paw of an animal, and the like.

FIG. 1A depicts a front view of the applicator 116. The front of the applicator 116 may be comprised of a front panel 117 constructed of, for example, cloth and/or paper. The panel 117 is used to deliver the activating solution to the body part. FIG. 1B depicts a back view of the applicator 116. The back of the applicator 116 may be comprised of a back panel 118 that may, in some embodiments, be a continuation of the front panel 117. In other embodiments, the back panel 118 may be separate from the front panel 117 and affixed to portions of the front panel via stitching, adhesives, spot welding, and other affixing technologies known in the art. The back panel 118 may be constructed of the same materials as the front panel 117, or, alternatively, the back panel 118 may be constructed of materials that are different from the front panel 117. The back panel terminates at an edge 119 to create an opening for the user's fingers. The back surface of the front panel 117 is exposed at the area 120.

FIG. 1C depicts an exposed view of the back surface of the front panel 117 created by cutting away the back panel 118 along the line 121. This view is for illustrative purposes only. The exposed view demonstrates an applicator pad 122 that is adhered to the back surface of the front panel 117 by adhesives, stitching, spot welding, and/or other affixing technologies known in the art. The applicator pad 122 may be constructed of permeable materials such as cotton, paper, and the like that facilitate the passage of the activating solution from the applicator pad 122 to the front panel 117 where it can be applied to a body part. In one aspect, the activating solution is formulated with a viscosity suitable to facilitate application with minimal waste and mess. In an alternate embodiment, a backing (not shown) is affixed to the back surface of the front panel 117 and the applicator pad 122 is positioned therebetween. In this embodiment the backing would be non-permeable so the solution does not move from the applicator pad 122 through the backing and into the pocket of the applicator 116. This keeps the solution off of the fingers of the wearer of the applicator 116. Similarly, the front surface of the front panel 117 may be temporarily covered with a removable, non-permeable covering (not shown). When the user is ready to use the applicator, the covering may be removed, thereby exposing the front surface of the front panel 117. The backing and the covering could be made of plastic.

Other exemplary configurations for the applicator 116 may include a stamping pad, a sponge, a sponge and wand arrangement, a tube containing the activating solution, and/or a brush. As described above, the applicator 116 may be packaged such that it already contains the activating solution. Alternatively, the activating solution may be packaged separately, and the user applies the activating solution to the applicator 116 in order to moisten the applicator 116. In one aspect, the activating solution is formulated to be colorless to minimize mess associated with the use of the kit 100. Additionally, the activating solution has a safety profile that allows it to be safely applied to a skin surface and washed off with soap and water when done. Any and all such aspects, and any combination thereof, are contemplated as being within the scope of the invention.

Turning now to FIG. 2, there is schematically depicted an enlarged cross-sectional view of the article 110 of FIG. 1 taken along the line 2-2 and is referenced generally by the numeral 200. The cross-sectional view 200 of the article 110 illustrates a substrate layer 210, areas 212 printed using visible ink materials, and an area 214 printed using a combination of visible ink materials and colorless ink materials (a key is provided with FIG. 2). The areas 212 correspond generally to the area 112 of FIG. 1, and the area 214 corresponds generally to the area 114 of FIG. 1. It is also contemplated that the areas 212 and 214 may comprise one single area that is printed using a combination of visible ink materials and colorless ink materials. Any and all such aspects, and any combination thereof, are contemplated as being within the scope of the invention.

As mentioned above, the substrate layer 210 may comprise paper, card stock, plastic, glass, metal, cloth, and/or wood and the like. The visible ink materials and the colorless ink materials are used to print a variety of solid areas, areas having textual messages, and areas having design elements such as swirls, dots, hearts, and the like onto the substrate layer 210. The content associated with the colorless ink materials remains hidden until activated by an activating solution. Thus, in practice, a user only perceives the hidden elements after activation of the colorless ink materials.

In one aspect, the visible ink materials are used to print a first pattern on the substrate layer 210. The colorless ink materials are used to print both a textual message that, when revealed, has a pattern corresponding to the first pattern printed using the visible ink materials, and a second pattern surrounding the textual message. Upon application of the activating solution, the textual message is revealed in the first pattern, and the second pattern is also revealed. The use of the second pattern acts to “outline” the shape of the letters making up the textual message, thereby helping to reveal the textual message.

FIG. 3 is a schematic representation of an exemplary process 300 used to reveal a hidden element of an article in accordance with an embodiment of the present invention. FIG. 3 includes a number of different scenes 310, 312, and 314 illustrating an adult and a young child working together to reveal the hidden element of a greeting card in a shape corresponding to the young child's hand. The scenes 310, 312, and 314 are merely exemplary and are used for illustrative purposes only. The scene 310 depicts the adult wearing an applicator mitt containing an activating solution and applying the activating solution to the child's palm. Of course if the child is older, or if the user is an adult, the user could easily apply the activating solution to his or her own other hand. Further, although the body part shown is a hand, other body parts such as fingers, a sole of a foot, etc., and/or a paw of an animal are contemplated as being within the scope of the invention.

The scene 312 illustrates the application of the child's palm coated with the activating solution onto the area of the greeting card containing the hidden element. The instructions and/or the packaging that accompany the greeting card may specify the areas onto which the gift giver's body part should contact. As well, the greeting card itself may have a visual indication as to where the gift giver's palm should be placed. Once the child's palm contacts the greeting card, the activating solution activates the colorless ink materials that are in contact with the activating solution. Contact thereby causes the colorless ink materials to become visible to the eye of the user in a shape corresponding to the palm of the child. The scene 314 illustrates the greeting card after the hidden elements have been revealed. As can be seen, the revealed hidden elements are in a shape corresponding to the child's palm. Further, the hidden elements are permanently revealed. The greeting card is now ready to be given to the recipient.

FIG. 4 depicts a flow diagram of an exemplary method 400 of providing a kit to reveal a hidden element of an article. At a step 410, an article printed using visible ink materials and colorless ink materials is provided to, for example, a store or an end user. The article may comprise a greeting card, a frame and insert, wall art, gift wrap, a holiday decoration, an ornament, a notebook or journal, and the like. At a step 412, an applicator containing an activating solution is also provided to, for example, the store or the end user. The applicator is shaped so that it can be used to apply the activating solution to a body part. In turn, contact between the body part and the article causes the activating solution to render the colorless ink materials permanently visible to the eye of the user in a shape corresponding to the shape of the body part.

Turning now to FIG. 5, a flow diagram depicts an exemplary method 500 of revealing a hidden element of an article. At a step 510, a user, such as the adult and child in FIG. 3, applies an activating solution to a body part. The activating solution may be applied by using an applicator, such as the applicator 116 of FIGS. 1A-1C. At a step 512, the body part coated with the activating solution is contacted with at least a portion of the article in order to reveal at least a portion of the hidden element in a shape corresponding to the body part. As described above, the hidden element may be printed using colorless ink materials that become visible subsequent to contact with the activating solution.

FIGS. 6-8 depict some exemplary articles having hidden elements revealed in a shape corresponding to a body part. FIG. 6 depicts an article comprising a frame and insert 600. The frame and insert 600 are printed using a combination of visible ink materials and colorless ink materials. For example, numerals 612 refer to one or more areas printed using visible ink materials. As can be seen, the visible ink materials are used to print design elements (e.g., stripes and circles), solid-colored areas, as well as textual elements (e.g., “When I grow up I want to be just like you”). The numeral 610 refers to an area having hidden elements revealed in a shape corresponding to the gift giver's hand. The hidden elements are printed using colorless ink materials in an area 614. With respect to the frame and insert 600, the hidden elements are textual messages (e.g., “Play,” “Giggles,” etc.) that relate to the textual message printed using the visible ink materials (“When I grow up I want to be just like you”). In other aspects, the textual messages and/or design elements printed using colorless ink materials may relate to the article itself. For instance, if the article is a Christmas ornament, the hidden elements may comprise phrases such as “Merry Christmas,” or “Happy Holidays,” and/or design elements such as Christmas trees and snowflakes. Any and all such aspects, and any combination thereof, are contemplated as being within the scope of the invention.

FIG. 7 is an illustration of wall art 700 that includes a plurality of areas 710 comprising hidden elements that have been revealed in the shape of the gift giver's hand(s). As well, the wall art 700 has areas 712 printed using visible ink materials. The hidden elements in the plurality of areas 710 are solid-colored and may comprise a variety a colors.

FIG. 8 is an unfolded blank of a greeting card 800 having a front panel 810 and an inside portion 812. The card 800 further includes an area 814 on the front panel 810 having both visible portions and hidden elements; a portion of the hidden elements 816 has been revealed in a shape corresponding to the card giver's hand. Like above, the visible portions of the area 814 are printed using visible ink materials and the hidden elements 816 are printed using colorless ink materials that become visible upon activation by an activating solution. The hidden elements 816 comprise a solid-colored area. Although the hidden elements 816 are depicted as being on the front panel 810 of the card 800, it is also contemplated that the hidden elements 816 may also be located on the inside portion 812. The front panel 810 may be connected to the inside portion 812 via a perforated fold line 818 that permits detachment of the front panel 810 from the card 800 to facilitate keeping of the gift giver-specific sentiment as a memento. A fold line 820 divides the inside portion 812 into left and right sides of the cards 800 interior.

The present invention has been described in relation to particular embodiments, which are intended in all respects to be illustrative rather than restrictive. Alternative embodiments will become apparent to those of ordinary skill in the art to which the present invention pertains without departing from its scope.

Various embodiments of the invention have been described to be illustrative rather than restrictive. Alternative embodiments will become apparent from time to time without departing from the scope of embodiments of the inventions. It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A kit for revealing a hidden element, the kit comprising:
an article having the hidden element, the article having printing thereon using one or more visible ink materials and the hidden element printed using one or more colorless ink materials; and
an applicator containing an activating solution, the applicator configured to apply the activating solution to a body part, wherein contact between the body part coated with the activating solution and the article causes the activating solution to reveal at least a portion of the hidden element in a shape corresponding to the body part.

2. The kit of claim 1, further comprising an instruction set having instructions for use of the kit.

3. The kit of claim 1, further comprising one or more objects configured to present the article for display.

4. The kit of claim 1, wherein the article comprises at least one of a greeting card, a frame and its corresponding insert, a notebook cover, gift wrap, wall art, and an ornament.

5. The kit of claim 1, wherein the one or more colorless ink materials comprise leuco dyes.

6. The kit of claim 1, wherein the hidden element comprises one or more solid-colored areas.

7. The kit of claim 1, wherein the hidden element comprises one or more design elements.

8. The kit of claim 1, wherein the one or more visible ink materials are used to print a first set of textual messages on the article, and wherein the one or more colorless ink materials are used to print a second set of textual messages on the article, the second set of textual messages comprising the hidden element.

9. The kit of claim 8, wherein the second set of textual messages is related to the article.

10. The kit of claim 8, wherein second set of textual messages is related to the first set of textual messages.

11. The kit of claim 1, wherein the hidden element is permanently revealed in the shape corresponding to the body part.

12. The kit of claim 1, wherein the applicator includes a panel and an applicator pad, wherein the applicator pad is saturated with the activating solution and abuts the panel, and wherein the panel is permeable, whereby the activating solution may pass from the applicator pad through the panel.

13. The kit of claim 12, wherein the visible ink materials are used to print a first pattern on the article and the colorless ink materials are used to print a textual message having the first pattern and one or more areas surrounding the textual message, the one or more surrounding areas having a second pattern, wherein contact between the body part coated with the activating solution and the article causes the activating solution to reveal the textual message such that the letters of the textual message having the first pattern are outlined by the one or more surrounding areas having the second pattern.

14. A method for revealing hidden elements of an article, the method comprising:
providing the article having the hidden elements, the article having printing thereon using one or more visible ink materials and the hidden elements printed using one or more colorless ink materials; and
providing an applicator containing an activating solution, the applicator configured to apply the activating solution to a body part, wherein contact between the article and the body part coated with the activating solution causes at least a portion of the hidden elements to be revealed in a shape corresponding to the body part.

15. The method of claim 14, further comprising:
providing an instruction set comprising instructions for applying the activating solution to the body part and applying the body part to an area of the article containing the hidden elements to reveal the at least the portion of the hidden elements of the article in the shape corresponding to the body part.

16. The method of claim 14, wherein the body part comprises a palm area of a hand.

17. A method for revealing a hidden element of an article, the method comprising:
applying an activating solution contained in an applicator to a body part;
contacting the body part coated with the activating solution with at least a portion of the article to reveal at least a portion of the hidden element in a shape corresponding to the body part.

18. The method of claim 17, wherein the hidden element of the article is printed on the article using one or more colorless ink materials.

19. The method of claim 18, wherein the activating solution is formulated to activate the one or more colorless ink materials such that the colorless ink materials become visible.

20. The method of claim 17, wherein the at least the portion of the hidden element in the shape corresponding to the body part is permanently revealed.

21. A kit for revealing a hidden element, the kit comprising:
an article having the hidden element, the article having printing thereon using one or more visible ink materials and the hidden element printed using one or more colorless ink materials; and
a mitt containing an activating solution, the mitt configured to apply the activating solution to a body part, wherein contact between the body part coated with the activating solution and the article causes the activating solution to reveal at least a portion of the hidden element in a shape corresponding to the body part.

22. The kit of claim 21, wherein the activating solution is contained in an applicator pad.
